(19) United States
(12) Patent Application Publication
(10) Pub. No.: US 2010/0302571 A1
(43) Pub. Date: Dec. 2, 2010

(54) Image forming system having information processing apparatus controlling guidance display on image forming apparatus

(75) Inventor: Masahiro Inoue, Osaka (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/800,398

(22) Filed: May 14, 2010

(30) Foreign Application Priority Data
May 27, 2009 (JP) JP2009-127629

(51) Int. Cl. G06F 3/12

(52) U.S. Cl. 358/1.13; 358/1.15

(57) ABSTRACT

An information processing apparatus includes: an input device receiving an input of information related to a document to be processed in the image forming apparatus and an input determining manner of output from the image forming apparatus as a result of processing of the document; a process request generating device, connected to receive an output from the input device, for generating a process request including guidance information necessary to generate guidance of an operation to be performed by a user in the image forming apparatus, so that the document is output from the image forming apparatus in a manner determined in accordance with an input received by the input device, and output manner specifying information specifying the manner of output of the document from the image forming apparatus; and a transfer device, connected to receive an output of the process request generating device, for transferring the process request generated by the process request generating device to the image forming apparatus.

### CROSS-REFERENCE TO RELATED APPLICATION

This nonprovisional application claims priority under 35 U.S.C. §119(a) on Patent Application No. 2009-127629 filed in Japan on May 27, 2009, the entire contents of which are hereby incorporated by reference.

### BACKGROUND OF THE INVENTION

1. Field of the Invention

The present invention relates to an image forming system having an image forming apparatus connected to a network and shared by a number of users (for example, a multifunction peripheral: MFP) and, more specifically, to an image forming system that helps a user to satisfactorily attain a required manner of output without confusing in, for example, a process of placing a document on a platen (contact glass surface).

2. Description of the Background Art

It has become increasingly common to connect an image forming apparatus having a printer function or a copy function to a network, to allow use by a plurality of users. Further, the number of apparatuses having a plurality of functions (modes) such as a copy function, a facsimile function (hereinafter “facsimile” may also be denoted as FAX or fax), a network-supported printer function and a scanner function, such as multifunction peripherals, is increasing. In such a multifunction peripheral, each user selects a basic function (mode) and sets a function of duplex (two-sided) printing or collective printing (such as 2-in-1 by which two pages of an original document are printed on one sheet, or 4-in-1 by which four pages of an original document are printed on one sheet), whereby images are formed on sheets of paper in a desired manner. Appropriate combinations of these functions come to be more frequently used.

When a user uses the copy mode of such a multifunction peripheral (image forming apparatus), the user inputs image data using the scanner function, performs image processing (such as collection) by inputting various instructions through an operation panel, and prints the results using the image forming function. For this purpose, it is required for the user to totally know the operations to attain various functions. A user not familiar with such operations takes time to input an instruction through an operation panel and, for that time period, other users cannot use the multifunction peripheral. In order to avoid such complicated operations, the following solution has been known.

Japanese Patent Laying-Open No. 2008-28962 discloses an image processing apparatus in which a print instruction sheet is printed to be used in a sheet scanning method, to enable flexible switching between execution/non-execution of reference image analyzing process or correcting process in accordance with various apparatus configurations and users' preferences. The image processing apparatus includes: a memory storing image data; an instruction sheet printing unit including a print instruction area for instructing printing to a recording unit, and a combination instruction area instructing combination of a drawn image and image data stored in the memory, for printing an instruction sheet instructing print control; a determining unit determining whether or not an image analyzing process is to be performed on the image data; an analyzing unit performing image analyzing process on the image data; and a print control unit printing, if it is determined by the determining unit to perform the image analyzing process, the image data that has been subjected to the image analyzing process on the instruction sheet.

In the image processing apparatus, the instruction sheet realizes, by the sheet scan method, settings necessary to perform drawing-combined printing. The print instruction area of the instruction sheet is an area allowing input of print control instruction and image processing instruction by marks. Here, the print control instruction and image processing instruction can be input using a mark-sensing card on which a desired setting is selected from among options offered in accordance with specifications of the image processing apparatus. By way of example, for the item “paper setting” in the print instruction area, the type of recording paper is selected by filling a mark. Then, the instruction sheet is read by the scanner function of image processing apparatus (MFP), and the sheet is set in the image processing apparatus. Thus, it is unnecessary for the user to perform the paper setting operation on the operation panel.

Japanese Patent Laying-Open No. 4-243270 discloses an automatic document feeder for a copy machine, which allows setting of copying conditions even at a place away from the copy machine. The automatic document feeder is mounted on a body of the copy machine, and a document feed tray is detachably provided on the body of automatic document feeder. The document feed tray is provided with: a display operation unit allowing setting and display of copying conditions and having a storage unit with an area for storing the set copying conditions; and a communication unit allowing communication with the body of copying machine through the automatic document feeder, when the document feed tray is mounted on the feeder body.

The automatic document feeder mounted on the body of copy machine consists of the body of automatic document feeder and the document feed tray, and the document feed tray is detachable from the body of automatic document feeder. The document feed tray is provided with a display operation unit allowing setting and display of copying conditions, and the display operation unit has a storage unit with an area for storing the set copying conditions. Therefore, even when the document feed tray is removed and copying conditions are set through the display operation unit, the set copying conditions are stored in the storage unit. Therefore, it is possible to set copying conditions at a place away from the copy machine. The user simply sets conditions and passes the tray to an operator, and the copying conditions can be received without the trouble of specifying the conditions, and the operator does not miss or confuse the copying conditions.

According to the techniques disclosed in patent documents above, a user who totally knows the method of setting various functions of a multifunction peripheral and the method of operating a multifunction peripheral registers a plurality of pieces of information related to settings of the multifunction peripheral, simply to save the trouble of setting.

More specifically, by using an instruction sheet or a detachable automatic document feeder, print setting is done in advance, and after the setting, the instruction sheet is read by a scanner or the detachable automatic document feeder is connected to a multifunction peripheral to have the setting read, at the site of the multifunction peripheral, whereby setting of the multifunction peripheral is done. Namely, these techniques simply save the trouble of print setting on the operation unit on the body of multifunction peripheral.

Though such techniques facilitate print setting and prevent setting errors, these techniques do not present easy guidance on operations of the multifunction peripheral to a user who is not familiar with the method of setting various functions of the multifunction peripheral and the method of operating the multifunction peripheral. Therefore, a user who is not familiar with the method of setting various functions of the multifunction peripheral and the method of operating the multifunction peripheral may make setting and operating errors, or may take time in setting and operation and, hence, it may be difficult for such a user to obtain a desired output (to obtain a printout) quickly.

### SUMMARY OF THE INVENTION

Therefore, it is preferable that even a user who is not familiar with the method of setting various functions of the multifunction peripheral and the method of operating the multifunction peripheral can easily and quickly obtain the desired output.

According to a first aspect, the present invention provides an information processing apparatus used in an information processing system in which a process request of an image forming apparatus is registered beforehand in an information processing apparatus, and the image forming apparatus operates based on the registered process request. The information processing apparatus includes: an input device receiving an input of information related to a document to be processed in the image forming apparatus, and an input determining manner of output from the image forming apparatus as a result of processing of the document; a process request generating device, connected to receive an output from the input device, for generating a process request including guidance information necessary to generate guidance of an operation to be performed by a user in the image forming apparatus, so that the document is output from the image forming apparatus in a manner determined in accordance with an input received by the input device, and output manner specifying information specifying the manner of output of the document from the image forming apparatus; and a transfer device, connected to receive an output of the process request generating device, for transferring the process request generated by the process request generating device to the image forming apparatus.

According to a second aspect, the present invention provides an image forming apparatus used in an information processing system in which a process request of an image forming apparatus is registered beforehand in an information processing apparatus, and the image forming apparatus operates based on the registered process request. The image forming apparatus includes: a display device; and a receiving device receiving the process request from the information processing apparatus. The process request includes guidance information necessary for generating guidance of an operation to be performed by a user in the image forming apparatus, and output manner specifying information specifying the manner of output of a document. The image forming apparatus further includes: a guidance display generating device, connected to receive an output of the receiving device, for generating and displaying on the display device guidance related to a user operation on the document in accordance with the guidance information included in the process request received by the receiving device; and an image processing control device, connected to receive an output of the receiving device, for executing an image forming process on the document to be output in the manner of output specified by the output manner specifying information, based on the output manner specifying information included in the process request received by the receiving device.

Preferably, the process request further includes operation mode setting information necessary for setting an operation mode of the image forming apparatus. The image forming apparatus further includes a setting device, connected to receive an output of the receiving device, for setting the image forming apparatus to operate in the operation mode, based on the mode setting information included in the process request received by the receiving device.

The image forming apparatus may further include one or a plurality of functional units each executing a specific function in outputting a document. The process request further includes function setting information specifying a function to be executed by any of the one or a plurality of functional units. The image forming apparatus further includes a function selecting unit, connected to receive an output of the receiving unit, for selecting and executing a function of the one or a plurality of functional units, based on the function setting information included in the process request received by the receiving unit.

According to a third aspect, the present invention provides an image forming system, including an information processing apparatus and an image forming apparatus capable of receiving information transferred from the information processing apparatus. The information processing apparatus includes: an input device receiving an input of information related to a document to be processed in the image forming apparatus, and an input determining manner of output from the image forming apparatus as a result of processing of the document; a process request generating device, connected to receive an output from the input device, for generating a process request including guidance information necessary to generate guidance of an operation to be performed by a user in the image forming apparatus, so that the document is output from the image forming apparatus in a manner determined in accordance with an input received by the input device, and output manner specifying information specifying the manner of output of the document from the image forming apparatus; and a transfer device, connected to receive an output of the process request generating device, for transferring the process request generated by the process request generating device to the image forming apparatus.

According to the information processing apparatus, the image forming apparatus and the image forming system, when a process request to be done in the image forming apparatus is registered by the user in the information processing apparatus (client computer), the process request is transmitted to the image forming apparatus, for example, through a network. The image forming apparatus stores the received process request, and when the user selects the process request on the image forming apparatus, guidance information is presented to the user, based on the process request information. By way of example, when the user actually places a document on the contact glass surface, guidance related to placement of the document, such as the guidance on direction (portrait/landscape) of the document and front/rear side of the document with respect to the contact glass surface, is presented. Following the guidance, a required output can be obtained easily. As a result, even a user who is not familiar with the method of setting various functions of the multifunction peripheral and the method of operating the multifunction peripheral can easily and quickly obtain the desired output.

Preferably, the image forming apparatus is operable in a plurality of operation modes. The information processing apparatus further includes: an operation mode selecting device receiving an input for selecting any of the plurality of operation modes; and a mode setting information generating device, connected to the operation mode selecting device, for generating mode setting information necessary for setting the image forming apparatus to the operation mode selected in accordance with the input received by the operation mode selecting device. The process request generating device is connected further to receive an output of the mode setting information generating device, and generates and applies to the transfer device the process request additionally including the mode setting information generated by the mode setting information generating device.

By such an approach, it becomes possible to automatically set the type of operation (operation mode) of the image forming apparatus.

More preferably, the image forming apparatus is operable by arbitrarily selecting one or a plurality of functions. The information processing apparatus further includes: a function selecting device receiving an input of selecting any function of the image forming apparatus; and a function setting information generating device, connected to receive an output from the function selecting device, responsive to the function selecting device receiving an input of selecting a function, for generating function setting information necessary for setting the function selected by the input received by the function selecting device, in the image forming apparatus. The process request generating device is connected further to receive an output of the function setting information generating device, and generates and applies to the transfer device the process request additionally including the function setting information generated by the function setting information generating device.

By such an approach, it becomes possible to automatically set the function (collection, duplex copy or the like) of the image forming apparatus.

The guidance information may be configured to be information related to placement of the document with respect to the document reading unit of the image forming apparatus.

By way of example, even when documents in portrait layout and landscape layout are mixed and collective copying or duplex copying is desired, the required output can be obtained easily by simply following the guidance information.

According to the present invention, in place of setting the mode and function by operating the image forming apparatus, the mode and function are registered in the information processing apparatus, and then, the registered mode and function are automatically set in the image forming apparatus. Further, a guidance related to the document operation by the user is presented based on the manner of output and the information related to the document, whereby the required output can be obtained easily by following the guidance. As a result, even a user who is not familiar with the method of setting various functions of the multifunction peripheral and the method of operating the multifunction peripheral can easily and quickly obtain the desired output.

According to a fourth aspect, the present invention provides, in an information processing apparatus communicable with an image forming apparatus, a method of setting the image forming apparatus. The method includes the steps of: receiving an input of information related to a document to be processed in the image forming apparatus, and an input determining manner of output from the image forming apparatus as a result of processing of the document; generating a process request including guidance information necessary to generate guidance of an operation to be performed by a user in the image forming apparatus, so that the document is output from the image forming apparatus in a manner determined in accordance with the input received at the receiving step, and output manner specifying information specifying the manner of output of the document from the image forming apparatus; and transferring the process request generated at the process request generating step to the image forming apparatus.

According to a fifth aspect, the present invention provides, in an image forming apparatus communicable with an information processing apparatus, a method of image formation in the image forming apparatus operating based on a process request on a document received from the information processing apparatus. The image forming apparatus includes a display device. The process request includes guidance information necessary for generating guidance of an operation to be performed by a user in the image forming apparatus, and output manner specifying information specifying the manner of output of a document. The method includes the steps of: generating and displaying on the display device guidance related to a user operation on the document in accordance with the guidance information included in the process request received from the information processing apparatus; and executing an image forming process on the document to be output in the manner of output specified by the output manner specifying information, based on the output manner specifying information included in the process request received from the information processing apparatus.

According to a sixth aspect, the present invention is directed to a computer program product including a computer readable storage medium. The storage medium stores a computer program causing, when executed by a computer, the computer to execute a method including the steps of: receiving an input of information related to a document to be processed in the image forming apparatus, and an input determining manner of output from the image forming apparatus as a result of processing of the document; generating a process request including guidance information necessary to generate guidance of an operation to be performed by a user in the image forming apparatus, so that the document is output from the image forming apparatus in a manner determined in accordance with the input received at the receiving step, and output manner specifying information specifying the manner of output of the document from the image forming apparatus; and transferring the process request generated at the process request generating step to the image forming apparatus.

According to a seventh aspect, the present invention is directed to a computer program product including a computer readable storage medium. The storage medium stores a computer program causing, when executed by a computer controlling an image forming apparatus, the computer to execute the method including the step of: receiving a process request to the image forming apparatus. The process request includes guidance information necessary for generating guidance of an operation to be performed by a user in the image forming apparatus, and output manner specifying information specifying the manner of output of a document. The method further includes the steps of: generating and displaying on the display device guidance related to a user operation on the document in accordance with the guidance information included in the process request received at the receiving step; and executing an image forming process on the document to be output in the manner of output specified by the output manner specifying information, based on the output manner specifying information included in the process request received at the receiving step.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an overall configuration of an image forming system in accordance with an embodiment of the present invention.

FIG. 2 is a functional block diagram showing hardware configuration of a client computer shown in FIG. 1.

FIG. 3 is a perspective view showing an appearance of the image forming apparatus shown in FIG. 1.

FIG. 4 schematically shows an internal configuration of the image forming apparatus shown in FIG. 1.

FIG. 5 is a functional block diagram showing hardware configuration of the image forming apparatus shown in FIG. 1.

FIG. 6 is a flowchart representing a control structure of a program executed by the client computer shown in FIG. 1.

FIG. 7 shows a structure of reserved job data transmitted from the client computer to the image forming apparatus shown in FIG. 1.

FIG. 8 is a (first) flowchart representing a control structure of a program executed by the image forming apparatus shown in FIG. 1.

FIG. 9 is a (second) flowchart representing a control structure of a program executed by the image forming apparatus shown in FIG. 1.

FIG. 10 shows a (first) example of an image displayed on a display of the client computer shown in FIG. 1.

FIG. 11 shows a (second) example of an image displayed on a display of the client computer shown in FIG. 1.

FIG. 12 shows a (first) example of an image displayed on an operation panel of the image forming apparatus shown in FIG. 1.

FIG. 13 shows a (second) example of an image displayed on an operation panel of the image forming apparatus shown in FIG. 1.

### DESCRIPTION OF THE PREFERRED EMBODIMENTS

In the embodiment below, the same components are denoted by the same reference characters. Their names and functions are also the same. Therefore, detailed description thereof will not be repeated. Description will be given assuming an image forming system as follows. When a user reserves a job of an image forming apparatus (multifunction peripheral: MFP) in a client computer (personal computer: PC), data of the reserved job is transmitted to the image forming apparatus through a network. The image forming apparatus stores the received data of reserved job. When the reserved job is selected in the image forming apparatus, the image forming apparatus is set to the function corresponding to the job and the guidance related to placement of the document is presented to the user, based on the data of reserved job.

The image forming apparatus forms an image on a sheet of recording paper in accordance with electro-photography. The image forming apparatus has a copy function, FAX function and scanner function (and it may further have a network printer function). The present invention, however, is not limited to the above, and the image forming apparatus having only the copy function, FAX function or scanner function, or an image forming apparatus having two of the three functions may be used. Further, the printing method is not limited to electro-photography.

[Overall System Configuration]

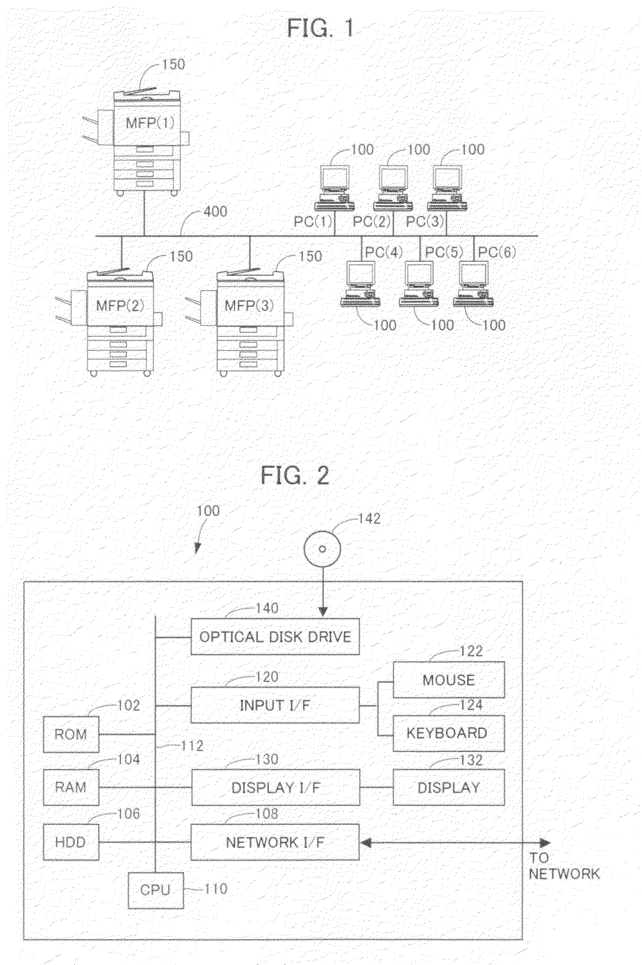

Referring to FIG. 1, an overall configuration of the image forming system in accordance with an embodiment of the present invention will be described. The image forming system includes: client computers 100 (PC (1) to PC (6)) as information processing apparatuses registering a job of an image forming apparatus 150 and transmitting data of the reserved job to image forming apparatus 150; and the image forming apparatuses 150 (MFP (1) to MFP (3)) storing the data of reserved job received from client computer 100, setting image forming apparatus 150 to a function corresponding to the job in accordance with the reserved job selected by the user, and presenting guidance related to placement of a document to the user. Client computers 100 and image forming apparatuses 150 are connected to be communicable to each other by a network line 400 in accordance with, for example, IEEE802.3. The network connection may be realized in wireless manner.

In the following (particularly in the figures), the client computer may be simply referred to as a PC, and the image forming apparatus may be simply referred to as an MFP.

[Hardware Configuration]

<Client Computer>

Referring to FIG. 2, client computer 100 forming the network image forming system in accordance with the present embodiment includes: a bus 112; a CPU (Central Processing Unit) 110 connected to bus 112; an ROM (Read Only Memory) 102 connected to bus 112; an RAM (Random Access Memory) 104 connected to bus 112; a hard disk (HDD) 106 connected to bus 112; an optical disk drive 140, connected to bus 112, on which an optical disk 142 is mountable, and capable of writing information to optical disk 142 and reading information from optical disk 142; an input interface (hereinafter referred to as “input I/F”) 120, connected to bus 112, for providing an interface for connection between a mouse 122 and a keyboard 124; a display interface (hereinafter referred to as a “display I/F”) 130, connected to bus 112, for providing an interface related to connection with a display 132; and a network interface (hereinafter referred to as a “network I/F”) 108 providing wired or wireless (in the present embodiment, wired) connection to network line 400. Client computer 100 may include a magnetic disk drive on which a magnetic disk is mountable, and capable of writing information to the magnetic disk and reading information from the magnetic disk, in place of/in addition to optical disk drive 140.

ROM 102, RAM 104, hard disk 106, network I/F 108, input I/F 120, display I/F 130 and optical disk drive 140 all operate in cooperation with each other under the control of CPU 110, and in client computer 100, realize processes of various applications. The applications may include, for example, word processor document forming process and spread sheet document forming process. Further, in addition to the applications, a process for setting a job of image forming apparatus 150 as a reserved job in response to a user request, and for transmitting the reserved job to image forming apparatus 150 is realized.

The computer program or programs causing client computer 100 to perform the processes described above are stored in optical disk 142 to be inserted to optical disk drive 140, and transferred to hard disk 106. Alternatively, the programs may be transmitted through network line 400 to client computer 100 and stored in hard disk 106. At the time of execution, the programs are loaded to RAM 104. The programs may be directly loaded to RAM 104 from optical disk 142 or through network line 400.

These programs include a plurality of instructions causing client computer 100 to perform prescribed processes. Some of the basic functions necessary to realize these operations are provided by an operating system (OS) operating on client computer 100 or a third-party program, or a module of various tool kits installed in client computer 100. Therefore, the program may not necessarily include all functions required to realize the method and system in accordance with the present embodiment. The program may include only the instructions executing a prescribed process as client computer 100 described above, by calling appropriate functions or “tools” in a controlled manner to attain the desired results. General operations of a computer as the substance of client computer 100 are well known and, therefore, description will not be given here.

<Image Forming Apparatus: Function>

In image forming apparatus 150, data of a reserved job received from client computer 100 is stored, image forming apparatus 150 is set to a function corresponding to the reserved job selected by the user, and guidance related to document placement is presented to the user. In addition to such functions, image forming apparatus 150 has an image forming function as a basic function. In the following, the basic function will be described first.

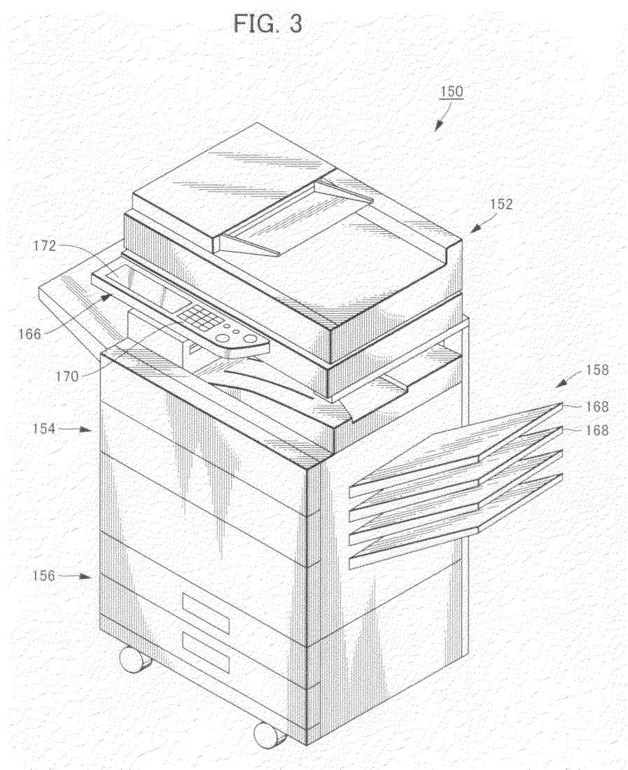

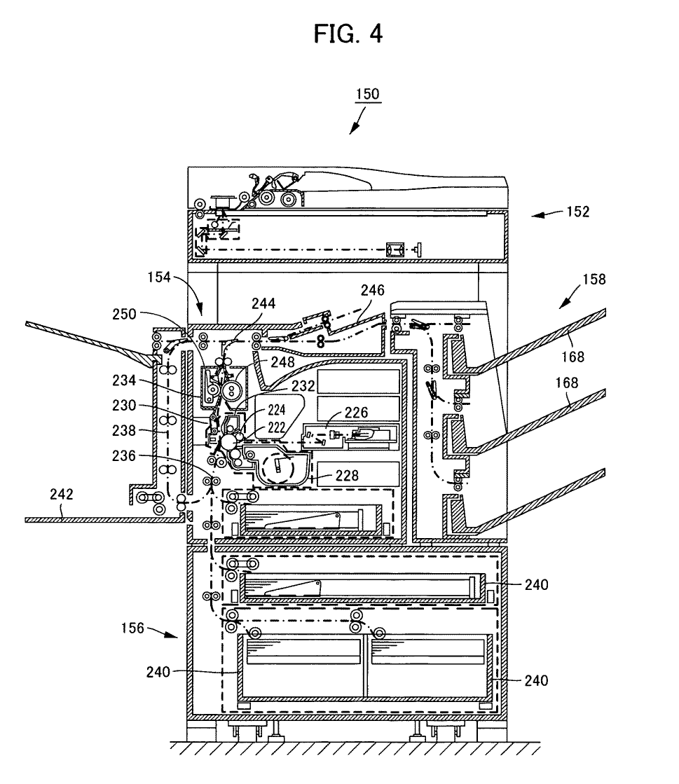

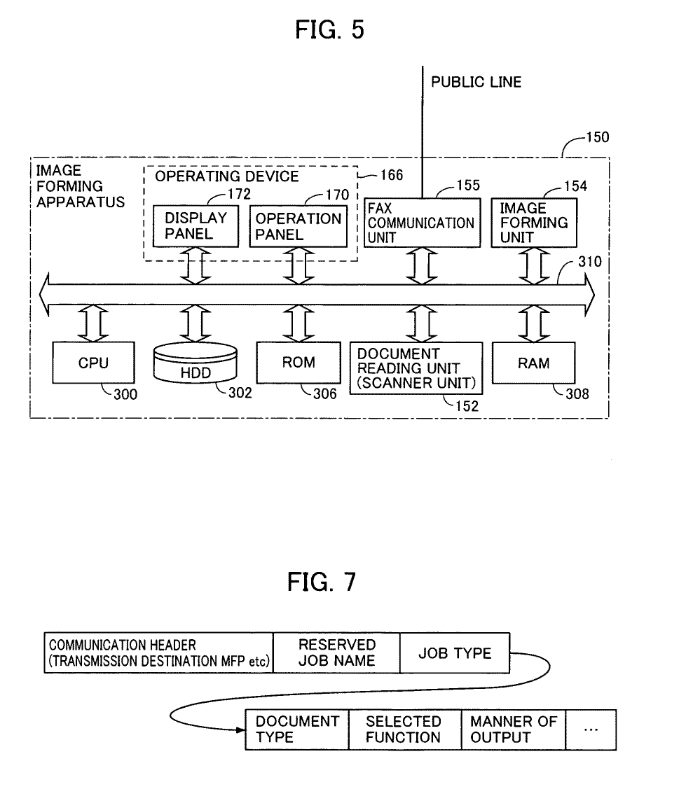

FIG. 3 shows an appearance of image forming apparatus 150. FIG. 4 schematically shows an internal configuration of image forming apparatus 150. FIG. 5 is a functional block diagram of image forming apparatus 150.

Referring to FIGS. 3 and 4, image forming apparatus 150 includes a document reading unit 152, an image forming unit 154, a paper feed unit 156, and a paper discharge unit 158.

### —Copy Mode—

In the following, an operation in the copy mode will be described. In the copy mode, mainly document reading unit (also referred to as a scanner unit) 152 and image forming unit 154 operate to realize the copy function.

In image forming apparatus 150, a document placed on a platen is read by document reading unit 152 as image data, the read image data is input to CPU 300 implemented, for example, by a microcomputer shown in FIG. 5, the image data is subjected to various image processing operations here, and the resulting image data is output to image forming unit 154.

Image forming unit 154 is for printing an image of the document represented by the image data on a recording medium (in most cases, on a sheet of recording paper), and it includes, by way of example, a photoreceptor drum 222, a charger 224, a laser scanning unit (hereinafter denoted as LSU) 226, a developer 228, a transfer device 230, a cleaning device 232, a fixing device 234 and a neutralizer, not shown.

In image forming unit 154, a main feeding path 236 and a reverse feeding path 238 are provided, and a sheet of recording paper fed from paper feed unit 156 is fed along main feeding path 236. Paper feed unit 156 draws out sheets of recording paper stacked on a paper feed cassette 240 or on a manual feed tray 242 one by one, and feeds the sheet of paper to main feeding path 236 of image forming unit 154.

While the sheet of recording paper is fed along main feeding path 236 of image forming unit 154, the sheet passes between photoreceptor drum 222 and transfer device 230, and further passes through fixing device 234, whereby printing is done on the sheet of recording paper.

Photoreceptor drum 222 rotates in one direction, and its surface is cleaned by cleaning device 232 and the neutralizer and, thereafter, uniformly charged by charger 224.

LSU 226 modulates the laser beam based on the image data to be printed, and repeatedly scans the surface of photoreceptor drum 222 with the laser beam in a main scanning direction, whereby an electrostatic latent image is formed on the surface of photoreceptor drum 222.

Developer 228 develops the electrostatic latent image by supplying toner to the surface of photoreceptor drum 222, and thus, a toner image is formed on the surface of photoreceptor drum 222.

Transfer device 230 transfers the toner image on the surface of photoreceptor drum 222 to the sheet of recording paper passing between transfer device 230 and the photoreceptor drum 222.

Fixing device 234 includes a heating roller 248 for heating the sheet of recording paper and a pressure roller 250 for pressing the sheet of recording paper. As the sheet of recording paper is heated by heating roller 248 and pressed by pressure roller 250, the toner image that has been transferred to the sheet of recording paper is fixed on the sheet. A heater is heated by electric power supplied to fixing device 234 and controlled such that temperature of heating roller 248 attains to an appropriate temperature for fixing.

At a position of connection between main feeding path and reverse feeding path 238, a separation pawl 244 is arranged. When printing is done only on one side of the sheet of recording paper, separation pawl 244 is so positioned that the sheet of recording paper fed from fixing device 234 is guided to paper discharge tray 246 or a paper discharge unit 158.

When printing is done on both sides of the sheet of recording paper, separation pawl 244 is turned to a prescribed direction, so that the sheet of recording paper is guided to reverse feeding path 238. The sheet of recording paper passes through reverse feeding path 238, turned upside-down and again fed to main feeding path 236, and while it is again fed along main feeding path, printing is done on its rear surface, and thereafter the sheet is guided to paper discharge tray 246 or to paper discharge unit 158.

The sheet of recording paper printed in the above-described manner is guided to paper discharge tray 246 or to paper discharge unit 158, and discharged to paper discharge tray 246 or to any of paper discharge trays 168 of paper discharge unit 158.

Paper discharge unit 158 may perform a process of sorting a plurality of printed sheets of paper to be output to different discharge trays 168, a process of punching each sheet of recording paper or a process of stapling the sheets of recording paper. Assume that a number of copies of the printing are to be prepared. In that case, sheets of recording paper are sorted and discharged to paper discharge trays 168 such that each tray 168 contains each set of printed sheets, and the set of printed sheets in each tray 168 is stapled or punched, whereby copies of prints are prepared.

—Facsimile Mode—

In the following, an operation in the facsimile mode will be described. In the facsimile mode, document reading unit (scanner unit) 152 and a FAX communication unit 155 mainly operate for a transmission operation and FAX communication unit 155 and image forming unit 154 mainly operate for a reception operation, whereby the facsimile function is realized.

Transmission Operation

In image forming apparatus 150, when the facsimile mode is designated, a document placed on a platen is read by document reading unit 152 as image data, the read image data is input to CPU 300 implemented, for example, by a microcomputer shown in FIG. 5, the image data is subjected to various image processing operations here, and the resulting image data is output to a FAX communication unit (FAX communication unit 155 of FIG. 5).

FAX communication unit 155 of image forming apparatus 150 on the transmitting side connects a designated transmitting side line to a designated transmission destination, converts the image data to communication data in compliance with facsimile transmission standard, and transmits the converted data to a facsimile machine (such as image forming apparatus 150 having the facsimile function) on the receiving side.

Communication Operation

When the line is connected, FAX communication unit 155 of image forming apparatus 150 on the receiving side detects a communication request signal from FAX communication unit 155 of image forming apparatus 150 on the transmitting side, and transmits an acknowledgement signal. Thereafter, by way of example, FAX communication units 155 pass performance information supported by transmitting side and receiving side, determine highest possible speed of communication and method of coding/code correction of image data, and set the method of communication of modems. Then, using the image signal format in accordance with the communication method, data is transmitted from FAX communication unit 155 of image forming apparatus 150 on the transmitting side to FAX communication unit 155 of image forming apparatus 150 on the receiving side. When transmission ends, the line is disconnected.

Reception Operation

FAX communication unit 155 of image forming apparatus 150 on the receiving side converts the received data to image data and passes the data to image forming unit 154. The received data may be converted to image data at image forming unit 154. Image forming unit 154 prints an image of a document represented by the image data converted from the received data on a sheet of recording paper, in a manner similar to the operation in the copy mode described above.

—Scanner Mode —

In the following, an operation in the scanner mode will be described. In the scanner mode, mainly by the operation of document reading unit (scanner unit) 152, the scanner function is realized.

In image forming apparatus 150, a document placed on a platen is read by document reading unit 152 as image data, the read image data is input to CPU 300, the image data is subjected to various image processing operations here, and the resulting image data is stored in a storage device or transmitted to a computer connected to the network through a network interface.

<Image Forming Apparatus: Control Block Configuration>

Referring to FIG. 5, image forming apparatus 150 further includes: an operating device 166 allowing setting related to the copy function, facsimile function and scanner function; an ROM 306 for storing programs and the like; a hard disk 302 as a non-volatile storage area capable of storing programs and data even when power is cut off; and an RAM (Random Access Memory) 208 for providing a storage area when a program is executed.

Image forming apparatus 150 further includes a bus 310 connected to document reading unit 152, image forming unit 154, FAX communication unit 155, operating device 166, ROM 306, hard disk 302 and RAM 308, and a CPU 300 connected to bus 310, for realizing general functions as the image forming apparatus.

ROM 306 stores programs and data necessary for controlling operations of image forming apparatus 150. CPU 300 controls image forming apparatus 150 in accordance with the programs and data stored in ROM 306, and executes control related to various functions of image forming apparatus 150.

As shown in FIG. 5, a public line is connected for transmitting/receiving image data, to FAX communication unit 155 of image forming apparatus 150.

RAM 308 provides a function of a working memory for temporarily storing results of operations and processes by CPU 300, and a function of a frame memory for storing image data.

Document reading unit 152, image forming unit 154, a flat, plate-shaped operation panel 170 and display panel 172 of operating device 166, ROM 306, hard disk 302 and RAM 308 are controlled by CPU 300 executing a prescribed program.

Operating device 166 includes: a plate-shaped operation panel 170 arranged on the right side on a surface of operating device 166, provided with hardware including ten keys and various other operation buttons; and a display panel 172 formed of a small, touch-panel liquid crystal display device, arranged on the central to the left side of operating device 166. Operation panel 170 and display panel 172 are held in one housing, and operating device 166 is formed integrally to be one piece.

In operating device 166, state of image forming apparatus 150, status of destination designation, and status of job processing are displayed on display panel 172. On a display area of liquid crystal display of display panel 172, selection buttons are displayed. When a portion where the selection button is displayed is pressed, the pressed position is detected by the touch panel. By comparing the display position of the selection button and the position where the touch panel is pressed using a program, setting of a function and instruction of an operation of image forming apparatus 150 becomes possible.

[Software Configuration]

Client computer 100 in accordance with the present embodiment executes a process of transmitting, when a job of image forming apparatus 150 is reserved in response to a request from a user, the data of reserved job to image forming apparatus 150. Receiving the data of reserved job from the client computer, image forming apparatus 150 stores the data of reserved job. When the reserved job is selected by the user, a process for setting image forming apparatus 150 to operate in the mode and function corresponding to the reserved job, and a process for presenting guidance related to document placement to the user are executed. Such processes are realized by software executed by the hardware configuration described above. In the following, the software configuration will be described.

<Client Computer>

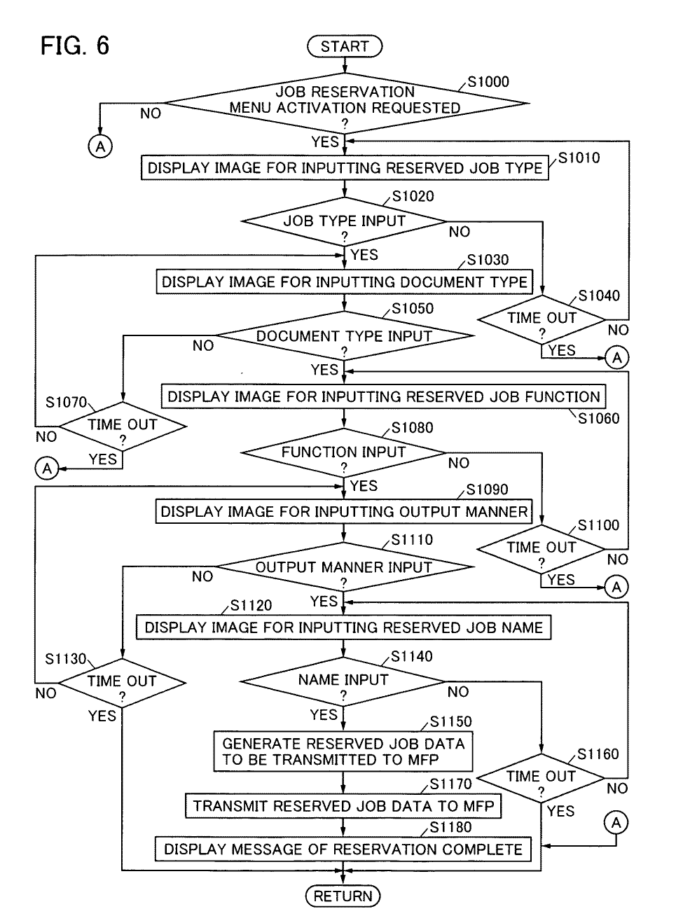

FIG. 6 is a flowchart representing a control structure of a program executed by client computer 100. CPU 110 of client computer 100 executes, in parallel with such a program, a program for realizing general functions of a computer connected to network line 400. The program, however, is not directly related to the characteristic portion of the present invention and, therefore, details thereof will not be described here.

Referring to FIG. 6, at step (hereinafter, “step” will be denoted by “S”) 1000, CPU 110 of client computer 100 (hereinafter simply referred to as CPU 110) determines whether or not activation of a reservation menu for reserving a job of image forming apparatus 150 is requested. By way of example, if a command for executing a specific program is input, CPU 110 determines that activation of a reservation menu for reserving a job of image forming apparatus 150 is requested. If activation of reservation menu is requested (YES at S100), the process proceeds to S1010. Otherwise (NO at S1000), the process ends.

At S1010, CPU 110 displays an image allowing input of a type (mode) of operation of the job to be reserved in image forming apparatus 150, on display 132.

At S1020, CPU 110 determines whether or not the type of job to be reserved is input by the user. If the user inputs the type of job to be reserved (YES at S1020), the process proceeds to S1030. Otherwise (NO at S1020), the process proceeds to S1040.

At S1030, CPU 110 displays an image allowing input of the document type (portrait/landscape/mixed) used in the job to be reserved, on display 132. Then, the process proceeds to S1050.

At S1040, CPU 110 determines whether or not a predetermined time has passed from when the image for inputting type (mode) of job to be reserved is displayed on display 132 and time out occurred. If time out occurred (YES at S1040), the process ends. Until time out is reached (NO at S1040), the process is returned to S1010, at which the input image is displayed on display 132, and waits until setting for the type (mode) of the job to be reserved is input by the user.

At S1050, CPU 110 determines whether or not the user has input the type of document used in the job to be reserved. If the user inputs the type of document used in the job to be reserved (YES at S1050), the process proceeds to S1060. Otherwise (NO at S1050), the process proceeds to S1070.

At S1060, CPU 110 displays an image allowing input of a function (collection of 2-in-1/4-in-1, duplex print, margin and the like) used in the job to be reserved, on display 132. Then, the process proceeds to S1080.

At S1070, CPU 110 determines whether a predetermined time has passed from when the image for inputting type of document used in the job to be reserved is displayed on display 132 and time out occurred. If time out occurred (YES at S1070), the process ends. Until time out is reached (NO at S1070), the process is returned to S1030, at which the input image is displayed on display 132, and waits until setting for the type of document used in the job to be reserved is input by the user.

At S1080, CPU 110 determines whether or not the function used in the job to be reserved is input by the user. If the user inputs the function used in the job to be reserved (YES at S1080), the process proceeds to S1090. Otherwise (NO at S1080), the process proceeds to S1100.

At S1090, CPU 110 displays an image allowing input of an intended manner of output to be output on a sheet of recording paper or the like by the job to be reserved, on display 132. Here, the intended manner of output means the manner of output to a sheet of recording paper by the reserved job when the operation is in the copy mode, the manner of output to a sheet of recording paper on the receiving side by the reserved job in the FAX mode, and the manner of output on display 132 of client computer 100 by the reserved job in the scanner mode.

At S1100, CPU 110 determines whether or not a predetermined time has passed from when the image for inputting the function used in the job to be reserved is displayed on display 132 and time out occurred. If time out occurred (YES at S1100), the process ends. Until time out is reached (NO at S1100), the process is returned to S1060, at which the input image is displayed on display 132, and waits until setting for the function used in the job to be reserved is input by the user.

At S1110, CPU 110 determines whether or not the user has input the intended manner of output to be output on a sheet of paper by the job to be reserved. If the user has input the intended manner of output to be output on a sheet of paper by the job to be reserved (YES at S1110, the process proceeds to S1120. Otherwise (NO at S1110), the process proceeds to S1130.

At S1120, CPU 110 displays an image allowing input of the name of the job to be reserved, on display 132. It is confirmed that the name of the job to be reserved can uniquely be identified in image forming apparatus 150 connected to the network, and then the name of the reserved job is established. Thereafter, the process proceeds to S1140. Further, if two or more image forming apparatuses 150 are connected to the network, a process allowing the user to specify the image forming apparatus 150 to be used is added.

At S1130, CPU 110 determines whether or not a predetermined time has passed from when the image for inputting the intended manner of output by the job to be reserved is displayed on display 132 and time out occurred. If time out occurred (YES at S1130), the process ends. Until time out is reached (NO at S1130), the process is returned to S1090, at which the input image is displayed on display 132, and waits until setting for the intended manner of output by the job to be reserved is input by the user.

At S1140, CPU 110 determines whether or not the name of the job to be reserved has been input by the user. If the name of the job to be reserved has been input by the user (YES at S1140), the process proceeds to S1150. Otherwise (NO at S1140), the process proceeds to S1160.

At S1150, CPU 110 forms reserved job data to be transmitted to image forming apparatus 150 based on the input information. Thereafter, the process proceeds to S1170.

At S1160, CPU 110 determines whether or not a predetermined time has passed from when the image for inputting the name of the job to be reserved is displayed on display 132 and time out occurred. If time out occurred (YES at S1160), the process ends. Until time out is reached (NO at S1160), the process is returned to S1120, at which the input image is displayed on display 132, and waits until the name of the job to be reserved is input by the user.

At S1170, CPU 110 transmits the formed reserved job data to image forming apparatus 150 through network line 400. At S1180, CPU 110 displays a message that reservation is made.

FIG. 7 shows a structure of the reserved job data transmitted from client computer 100 to image forming apparatus 150. As shown in FIG. 7, the reserved job data includes a communication header (for example, address of the image forming apparatus as the transmission destination, data type and the like) for controlling network communication, the name of reserved job, the job type (mode), the document type, the selected function, the manner of output . . . . A plurality of functions may be selected.

In image forming apparatus 150 receiving the reserved job data shown in FIG. 7, the type (mode) of operation and function of the image forming apparatus are automatically set, and it is unnecessary for the user to set using the operation panel.

<Image Forming Apparatus>

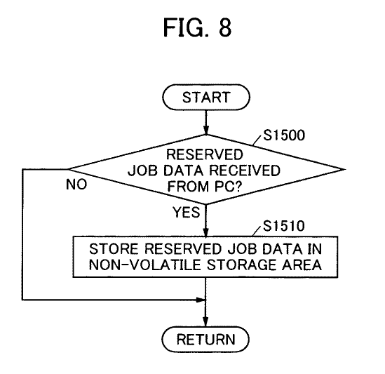

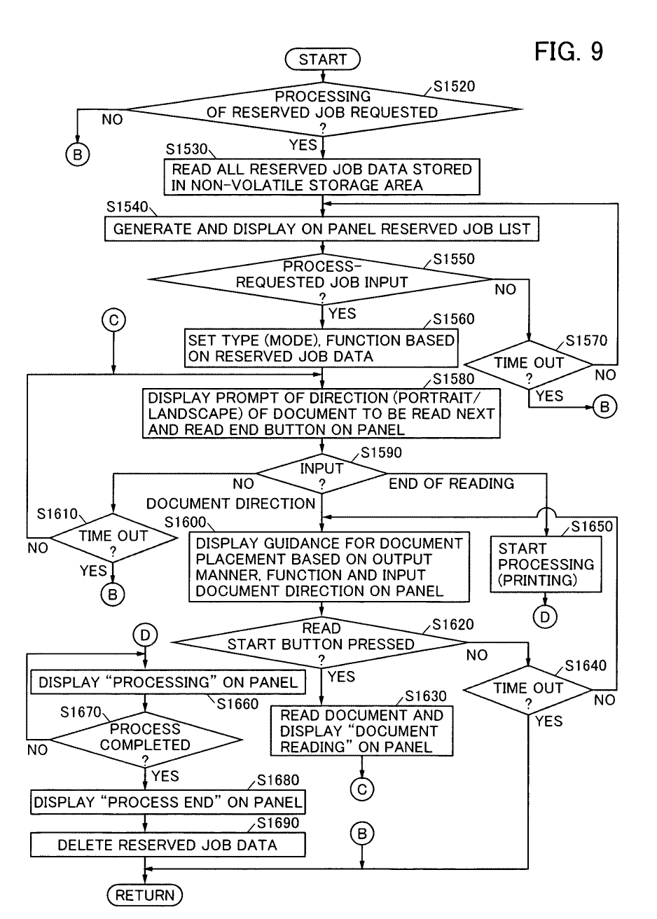

FIGS. 8 and 9 are flowcharts representing control structures of programs executed by image forming apparatus 150. In parallel with such programs, CPU 300 of image forming apparatus 150 executes a program for realizing general functions of an image forming apparatus connected to network line 400. The program, however, is not directly related to the characteristic portions of the present invention and, therefore, details thereof will not be described here.

Referring to FIG. 8, at S1500, CPU 300 of image forming apparatus 150 (hereinafter simply referred to as CPU 300) determines whether or not the reserved job data is received from client computer 100. If the reserved job data is received (YES at S1500), the process proceeds to S1510. Otherwise (NO at S1500), the process ends.

At S1510, CPU 300 stores the received reserved job data in a non-volatile storage area (hard disk 302). Hard disk 302 stores one or more reserved job data transmitted from client computer 100.

Referring to FIG. 9, at S1520, CPU 300 determines whether or not processing of a reserved job is requested. By way of example, if a specific button (no matter whether a hardware button or software button) on operating device 166 is pressed, CPU 300 determines that processing of a reserved job is requested in image forming apparatus 150. If processing of a reserved job is requested (YES at S1520), the process proceeds to S1530. Otherwise (NO at S1520), the process ends.

At S1530, CPU 300 reads all reserved job data stored in the non-volatile storage area (hard disk 302). At S1540, CPU 300 creates a reserved job list based on the reserved job data read from hard disk 320, and displays the list on display panel 172.

At S1550, CPU 300 determines whether or not there is an input of a reserved job to be processed from the user. If there is an input of the reserved job to be processed from the user (YES at S1550), the process proceeds to S1560. Otherwise (NO at S1550), the process proceeds to S1570.

At S1560, CPU 300 sets the type (mode) and function of image forming apparatus 150 based on the reserved job data. At this time, based on the job type and the selected function of the reserved job data shown in FIG. 7, CPU 300 determines the type (mode) and function of image forming apparatus 150 itself. Thus, it is unnecessary for the user to input the type (mode) and function of image forming apparatus 150. Then, the process proceeds to S1580.

At S1570, CPU 300 determines whether or not a predetermined time has passed from when the reserved job list is displayed on display panel 172 and time out occurred. If time out occurred (YES at S1570), the process ends. Until time out is reached (NO at S1570), the process is returned to S1540, at which the reserved job list is displayed on display panel 172, and waits until the reserved job of which processing is requested is input by the user.

At S1580, CPU 300 displays prompts related to the direction (portrait/landscape) of the document to be read next and a “READ END” button, on display panel 172.

At S1590, CPU 300 determines whether or not there is an input of the direction (portrait/landscape) of the document to be read next and the “READ END” button from the user. If the user inputs the direction (portrait/landscape) of the document to be read next (document direction at S1590), the process proceeds to S1600. If the user presses the “READ END” button (end of reading at S1590), the process proceeds to S1650. If the determinations are both negative (NO at S1590), the process proceeds to S1610.

At S1600, CPU 300 displays guidance for placing a document, based on the desired manner of output, the selected function and the direction of input document, on display panel 172. At this time, CPU 300 displays on display panel 172 how to place the document (direction of the document and front/rear side of the document with respect to the contact glass surface), based on the document type, selected function and manner of output as well as the direction of the input (to be read next) document in the reserved job data shown in FIG. 7. Then, the process proceeds to S1620.

At S1610, CPU 300 determines whether or not a predetermined time has passed from when the prompts related to the direction (portrait/landscape) of the document to be read next and “READ END” button are displayed on display panel 172 and time out occurred. If time out occurred (YES at S1610), the process ends. Until time out is reached (NO at S1610), the process is returned to S1580, at which the prompts related to the direction (portrait/landscape) of the document to be read next and “READ END” button are displayed on display panel 172, and waits until the direction of the document or end-of-reading is input by the user.

At S1620, CPU 300 determines whether or not a read-start button is pressed. By way of example, if a software button “READ START” of operating device 166 is pressed, CPU 300 determines that the read-start button is pressed. If the read-start button is pressed (YES at S1620), the process proceeds to S1630. Otherwise (NO at S1620), the process proceeds to S1640.

At S1630, CPU 300 reads a document by document reading unit (scanner unit) 152, and displays a notice of “DOCUMENT READING” on display panel 172. Then, the process returns to S1580.

At S1640, CPU 300 determines whether or not a predetermined time has passed from when the guidance for placing the document is displayed on display panel 172 and time out occurred. If time out occurred (YES at S1640), the process ends. Until time out is reached (NO at S1640), the process is returned to S1600, at which the guidance for placing the document is displayed on display panel 172, and waits until the read-start button is pressed by the user.

At S1650, CPU 300 starts processing (printing). At S1660, CPU 300 displays a notice of “PROCESSING” on display panel 172. At S1670, CPU 300 determines whether the processing (printing) is completed. If the processing (printing) is completed (YES at S1670), the process proceeds to S1680. Otherwise (NO at S1670), the process returns to S1660.

At S1680, CPU 300 displays “END OF PROCESSING” on display panel 172. At S1690, CPU 300 deletes the reserved job data stored in the non-volatile storage area (hard disk 302).

[Operation]

Operations of client computer 100 and image forming apparatus 150 in accordance with the present embodiment based on the configurations and flowcharts as above will be described with reference to examples of display.

<Job Reservation on Client Computer>

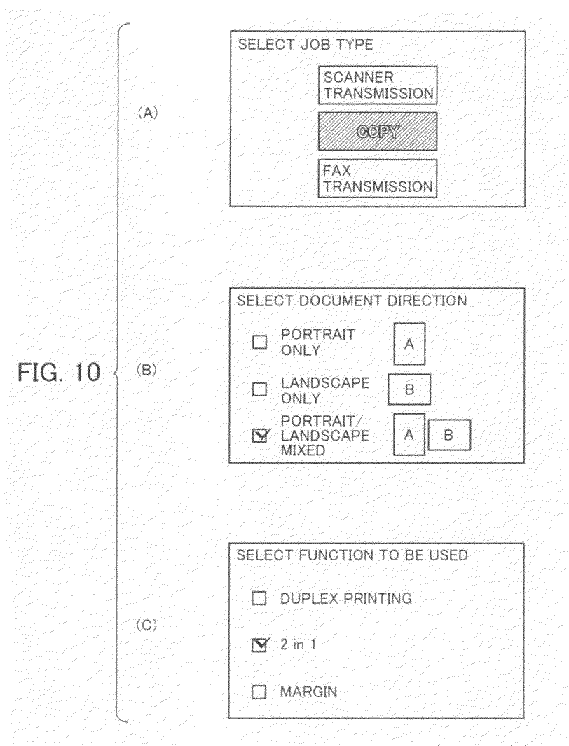

If the user operates mouse 122 or keyboard 124 of client computer 100 and thereby inputs a command for executing a reservation menu program for reserving a process in image forming apparatus 150 (YES at S1000), an image allowing selection of a type (mode) of operation in image forming apparatus of the job to be reserved is displayed on display 132. FIG. 10 (A) shows an example of the image displayed on display 132 at this time.

Before time out (NO at S1040), if the user selects “COPY” as the type (mode) of operation by, for example, clicking the “COPY” button by a mouse (YES at S1020), the image is changed, and a graphical image allowing input of document type is displayed on display 132 (S1030). FIG. 10 (B) shows an example of the image displayed on display 132 at this time.

Before time out (NO at S1070), if the user selects “PORTRAIT/LANDSCAPE MIXED” as the document type by, for example, checking a check box corresponding to the “PORTRAIT/LANDSCAPE MIXED” by a mouse (YES at S1050), the image is changed, and a graphical image allowing selection of a function is displayed on display 132 (S1060). FIG. 10 (C) shows an example of the image displayed on display 132 at this time.

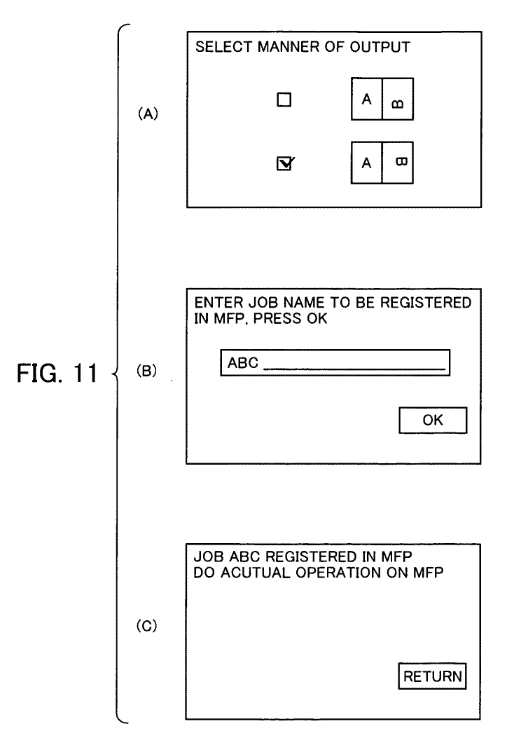

Before time out (NO at S1100), if the user selects “2-in-1” as the selected function by, for example, checking a check box corresponding to the “2-in-1” by a mouse (YES at S1080), the image is changed, and a graphical image allowing input of a desired manner of output is displayed on display 132 (S1090). FIG. 11 (A) shows an example of the image displayed on display 132 at this time.

Before time out (NO at S1130), if the user selects a desired manner of printing by, for example, checking a check box corresponding to the desired manner of output (in the case of copying operation, desired manner of printing) by a mouse (YES at S1110), the image is changed, and a graphical image allowing input of the name of reserved job is displayed on display 132 (S1120). FIG. 11 (B) shows an example of the image displayed on display 132 at this time.

Before time out (NO at S1160), if the user inputs the name of reserved job through keyboard 124 (YES at S1140), reserved job data (FIG. 7) to be transmitted to image forming apparatus 150 is formed (S1150), and the reserved job data is transmitted to image forming apparatus 150 by which processing is requested by the user (S1170). Then, the image is changed, and a message indicating completion of reservation is displayed on display 132 (S1180). FIG. 11 (C) shows an example of the image displayed on display 132 at this time.

<Execution of Reserved Job by Image Forming Apparatus>

If the reserved job data is received from client computer 100 (YES at S1500), image forming apparatus 150 stores the received reserved job data in hard disk 302 as the non-volatile storage area of itself (S1510).

When the user who registered the job on client computer 100 takes a document to the site of image forming apparatus 150 and presses a button corresponding to the reserved job processing provided on operating device 166 (YES at S1520), one or more reserved job data stored in hard disk 302 are read (S1530), and the reserved job list is created (S1540).

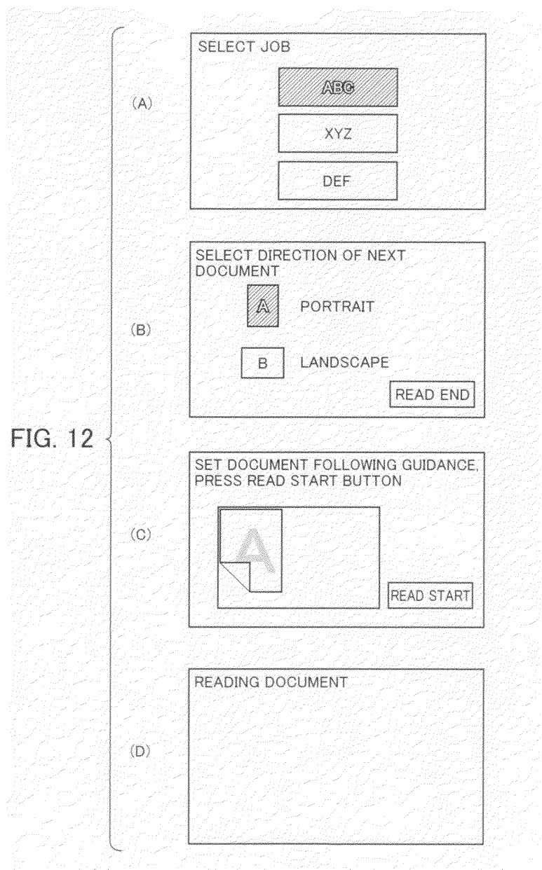

Based on the created reserved job list, a list of reserved job names is displayed on display panel 172 (S1550). FIG. 12 (A) shows an example of the image displayed on display panel 172 at this time.

Before time out (NO at S1570), if the user selects a job of which processing is requested from the reserved jobs (YES at S1550), the type (mode) and function of image forming apparatus 150 are set (S1560) based on the reserved job data (FIG. 7) of the selected reserved job. Then, the image is changed, and prompts related to the direction (portrait/landscape) of the document to be read next and “READ END” button are displayed on display panel 172 (S1580). FIG. 12 (B) shows an example of the image displayed on display panel 172 at this time.

Before time out (NO at S1610), if the user selects “PORTRAIT” as the direction of document to be read next (document direction at S1590), the image is changed, and guidance for placing the document is displayed on display panel 172. FIG. 12 (C) shows an example of the image displayed on display panel 172 at this time. As shown in FIG. 12 (C), the direction of document and front/rear side of the document with respect to the contact glass surface are graphically displayed on display panel 172. In the example shown in FIG. 12 (C), the printed surface of document faces the contact glass (the document is placed face down). Here, display in animation (video) may be preferred.

Before time out (NO at S1640), if the user presses “READ START” button (YES at S1620), the document is read by document reading unit (scanner unit) 152, and a message that the document is being read is displayed on display panel 172 (S1630). FIG. 12 (D) shows an example of the image displayed on display panel 172 at this time. When reading of the document ends, the image is changed, and an image of FIG. 12 (B) (with the portrait document not selected) is displayed on display panel 172 (S1590).

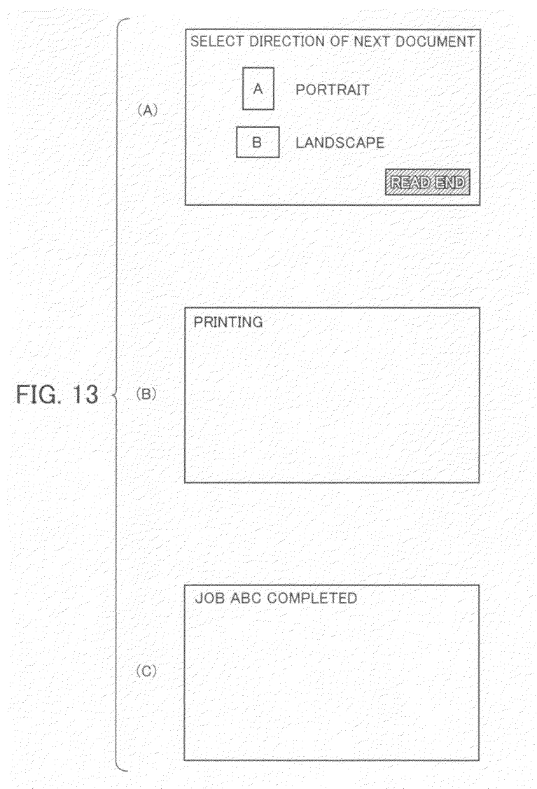

If there is a next document, the document is read in the similar manner as described above. If there is no document to be read any more, the user presses “READ END” button while the image of FIG. 13 (A) is displayed on display panel 172 (end of reading at S1590). When the processing (printing) starts (S1650), the image is changed, and an image indicating that printing is being done is displayed on display panel 172 (S1660). FIG. 13 (B) shows an example of the image displayed on display panel 172 at this time.

When the processing (printing) ends (YES at S1670), the image is changed, and an image indicating the end of processing is displayed on display panel 172. FIG. 13 (C) shows an example of the image displayed on display panel 172 at this time. Further, the reserved job data stored in the non-volatile storage area (hard disk 302) is deleted (S1690).

As described above, according to the image forming system in accordance with the present embodiment, if a job of an image forming apparatus is reserved by a user on a client computer, the reserved job data is transmitted to the image forming apparatus through a network. The image forming apparatus stores the received reserved job data, and when the user selects the reserved job in the image forming apparatus, the image forming apparatus is set to the function in accordance with the job, based on the reserved job data. When the user actually places a document on a contact glass, guidance related to placement of the document is presented. Here, direction of the document (portrait/landscape) and front/rear side of the document with respect to the contact glass surface are displayed on a display panel. Even if portrait and landscape documents are mixed and collective or duplex copying is to be done, the desired output can easily be obtained simply by following the guidance. Further, the type (mode) of operation and function (collection, duplex copy and the like) of the image forming apparatus are automatically set. Therefore, it is possible for the user to obtain the desired printout simply by selecting the reserved job registered using the client computer and placing the document or documents on the contact glass in accordance with the graphically displayed guidance. As a result, even a user who is not familiar with the method of setting various functions of the multifunction peripheral and the method of operating the multifunction peripheral can easily and quickly obtain the desired output.

—Modification—

(1) Examples of the guidance displayed on display panel 172 of image forming apparatus 150 are as follows. In the copy mode, as described in the foregoing, the guidance relates to the direction of the document and front/rear side of the document with respect to the contact glass surface, to have the desired output printed on the sheet of recording paper. In the scanner mode, the guidance relates to the direction of the document and front/rear side of the document with respect to the contact glass surface, to have the desired output displayed on a display of a computer. In the FAX mode, the guidance relates to the direction of the document and front/rear side of the document with respect to the contact glass surface, to have the desired output printed on the sheet of recording paper at the destination of FAX transmission. Further, in the FAX mode, a telephone number as the FAX transmission destination may be input by client computer 100, and the guidance related to the FAX destination information may be presented for confirmation on the image forming apparatus. Such guidance is very effective at the time of simultaneous broadcast. It is also possible, on client computer 100, to select a speed dialing number or an abbreviated telephone number, if registered information of telephone numbers is obtained in advance from image forming apparatus 150.

(2) The number of image forming apparatuses connected to a network is not limited to one, and two or more may be connected as shown in FIG. 1. In such a case, the image forming apparatuses are not always of the same type. Therefore, the apparatuses may not have the same functions. If the image forming apparatuses 150 connected to a network are of different types, it is preferred that different graphical interfaces are displayed on client computer 100 for different types of image forming apparatuses 150. More specifically, using identification information (such as address information on the network) of image forming apparatus 150, client computer 100 specifies an image forming apparatus 150 as the transmission destination (to be used) from among a plurality of image forming apparatuses 150, and transmits the reserved job data thereto.

(3) The filing function (the function of scanning a document using document reading unit 152, and transmitting to the hard disk in image forming apparatus 150 or in client computer 100) is the same as the scanning function.

(4) The reserved job data may be transmitted from client computer 100 to image forming apparatus 150 through wired or wireless network, or transmitted using other short distance radio communication standard (for example, Bluetooth (R)), or using a recording medium such as USB (Universal Serial Bus) memory.

(5) Though the processing is stopped as needed when “time out” occurs in the flowcharts described above, it is also possible to wait until an input is made for a process, to return the control to an appropriate process step, or to display a prompt to stop processing and to stop processing after the user inputs a confirmation in response.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An information processing apparatus, used in an information processing system having a process request of an image forming apparatus registered beforehand in an information processing apparatus, and the image forming apparatus operating based on the registered process request, comprising:
an input device receiving an input of information related to a document to be processed in said image forming apparatus, and an input determining manner of output from said image forming apparatus as a result of processing of said document;
a process request generating device, connected to receive an output from said input device, for generating a process request including guidance information necessary to generate guidance of an operation to be performed by a user in said image forming apparatus, so that said document is output from said image forming apparatus in a manner determined in accordance with an input received by said input device, and output manner specifying information specifying the manner of output of the document from said image forming apparatus; and
a transfer device, connected to receive an output of said process request generating device, for transferring the process request generated by said process request generating device to said image forming apparatus.

2. The information processing apparatus according to claim 1 wherein
said image forming apparatus is operable in a plurality of operation modes;
said information processing apparatus further comprising:
an operation mode selecting device receiving an input for selecting any of said plurality of operation modes; and
a mode setting information generating device, connected to said operation mode selecting device, for generating mode setting information necessary for setting said image forming apparatus to the operation mode selected in accordance with the input received by said operation mode selecting device; wherein
said process request generating device is connected further to receive an output of said mode setting information generating device, and generates and applies to said transfer device the process request additionally including the mode setting information generated by said mode setting information generating device.

3. The information processing apparatus according to claim 2, wherein
said image forming apparatus is operable by arbitrarily selecting one or a plurality of functions;
said information processing apparatus further comprising:
a function selecting device receiving an input of selecting any function of said image forming apparatus; and
a function setting information generating device, connected to receive an output from said function selecting device, responsive to said function selecting device receiving an input of selecting a function, for generating function setting information necessary for setting the function selected by the input received by said function selecting device, in said image forming apparatus; wherein
said process request generating device is connected further to receive an output of said function setting information generating device, and generates and applies to said transfer device the process request additionally including the function setting information generated by said function setting information generating device.

4. The information processing apparatus according to claim 1, wherein
said image forming apparatus is operable by arbitrarily selecting one or a plurality of functions;
said information processing apparatus further comprising:
a function selecting device receiving an input of selecting any function of said image forming apparatus; and
a function setting information generating device, connected to receive an output from said function selecting device, responsive to said function selecting device receiving an input of selecting a function, for generating function setting information necessary for setting the function selected by the input received by said function selecting device, in said image forming apparatus; wherein
said process request generating device is connected further to receive an output of said function setting information generating device, and generates and applies to said transfer device the process request additionally including the function setting information generated by said function setting information generating device.

5. An image forming apparatus, used in an information processing system having a process request of an image forming apparatus registered beforehand in an information processing apparatus, and the image forming apparatus operating based on the registered process request, comprising:
a display device; and
a receiving device receiving said process request from said information processing apparatus; wherein
said process request includes guidance information necessary for generating guidance of an operation to be performed by a user in said image forming apparatus, and output manner specifying information specifying the manner of output of a document;
said image forming apparatus further comprising:
a guidance display generating device, connected to receive an output of said receiving device, for generating and displaying on said display device guidance related to a user operation on the document in accordance with the guidance information included in the process request received by said receiving device; and
an image processing control device, connected to receive an output of said receiving device, for executing an image forming process on the document to be output in the manner of output specified by the output manner specifying information, based on the output manner specifying information included in the process request received by the receiving device.

6. The image forming apparatus according to claim 5, wherein
said guidance is information related to placement of a document on a document reading unit of said image forming apparatus.

7. The image forming apparatus according to claim 5, wherein
said process request further includes operation mode setting information necessary for setting an operation mode of said image forming apparatus;
said image forming apparatus further comprising
a setting device, connected to receive an output of said receiving device, for setting the image forming apparatus to operate in the operation mode, based on said mode setting information included in the process request received by said receiving device.

8. The image forming apparatus according to claim 5, further comprising
one or a plurality of functional units each executing a specific function in outputting a document; wherein
said process request further includes function setting information specifying a function to be executed by any of said one or a plurality of functional units;
said image forming apparatus further comprising
a function selecting unit, connected to receive an output of said receiving unit, for selecting and executing a function of said one or a plurality of functional units, based on the function setting information included in the process request received by said receiving unit.

9. The image forming apparatus according to claim 5, further comprising:
a storage device, connected to receive an output of said receiving device, for storing one or a plurality of process requests received by said receiving device; and
a process request selecting device, connected to said storage device to allow input to/output from said storage device, responsive to a user instruction, for selecting any of one or a plurality of process requests stored in said storage device, and applying to said guidance display generating device and said image processing control device.

10. An image forming system, comprising an information processing apparatus and an image forming apparatus capable of receiving information transferred from said information processing apparatus; wherein
said information processing apparatus includes
an input device receiving an input of information related to a document to be processed in said image forming apparatus, and an input determining manner of output from said image forming apparatus as a result of processing of said document,
a process request generating device, connected to receive an output from said input device, for generating a process request including guidance information necessary to generate guidance of an operation to be performed by a user in said image forming apparatus, so that said document is output from said image forming apparatus in a manner determined in accordance with an input received by said input device, and output manner specifying information specifying the manner of output of the document from said image forming apparatus, and
a transfer device, connected to receive an output of said process request generating device, for transferring the process request generated by said process request generating device to said image forming apparatus.

11. The image forming system according to claim 10, wherein
said image forming apparatus is operable in a plurality of operation modes;
said information processing apparatus further comprising:
an operation mode selecting device receiving an input for selecting any of said plurality of operation modes; and
a mode setting information generating device, connected to said operation mode selecting device, for generating mode setting information necessary for setting said image forming apparatus to the operation mode selected in accordance with the input received by said operation mode selecting device; wherein
said process request generating device is connected further to receive an output of said mode setting information generating device, and generates and applies to said transfer device the process request additionally including the mode setting information generated by said mode setting information generating device.

12. The image forming system according to claim 11, wherein
said image forming apparatus is operable by arbitrarily selecting one or a plurality of functions;
said information processing apparatus further comprising:
a function selecting device receiving an input of selecting any function of said image forming apparatus; and
a function setting information generating device, connected to receive an output from said function selecting device, responsive to said function selecting device receiving an input of selecting a function, for generating function setting information necessary for setting the function selected by the input received by said function selecting device, in said image forming apparatus; wherein
said process request generating device is connected further to receive an output of said function setting information generating device, and generates and applies to said transfer device the process request additionally including the function setting information generated by said function setting information generating device.

13. The image forming system according to claim 10, wherein
said image forming apparatus is operable by arbitrarily selecting one or a plurality of functions;
said information processing apparatus further comprising:
a function selecting device receiving an input of selecting any function of said image forming apparatus; and
a function setting information generating device, connected to receive an output from said function selecting device, responsive to said function selecting device receiving an input of selecting a function, for generating function setting information necessary for setting the function selected by the input received by said function selecting device, in said image forming apparatus; wherein
said process request generating device is connected further to receive an output of said function setting information generating device, and generates and applies to said transfer device the process request additionally including the function setting information generated by said function setting information generating device.

14. The image forming system according to claim 10, wherein
said process request further includes operation mode setting information necessary for setting an operation mode of said image forming apparatus;
said image forming apparatus further comprising
a setting device, connected to receive an output of said receiving device, for setting the image forming apparatus to operate in the operation mode, based on said mode setting information included in the process request received by said receiving device.

15. The image forming system according to claim 10, wherein
said image forming apparatus further includes one or a plurality of functional units each executing a specific function in outputting a document;
said process request further includes function setting information specifying a function to be executed by any of said one or a plurality of functional units;
said image forming apparatus further includes a function selecting unit, connected to receive an output of said receiving unit, for selecting and executing a function of said one or a plurality of functional units, based on the function setting information included in the process request received by said receiving unit.

16. The image forming system according to claim 15, wherein
said image forming apparatus further includes
a storage device, connected to receive an output of said receiving device, for storing one or a plurality of process requests received by said receiving device; and
a process request selecting device, connected to said storage device to allow input to/output from said storage device, responsive to a user instruction, for selecting any of one or a plurality of process requests stored in said storage device, and applying to said guidance display generating device and said image processing control device.

17. In an information processing apparatus communicable with an image forming apparatus, a method of setting said image forming apparatus, comprising the steps of;
receiving an input of information related to a document to be processed in said image forming apparatus, and an input determining manner of output from said image forming apparatus as a result of processing of said document;
generating a process request including guidance information necessary to generate guidance of an operation to be performed by a user in said image forming apparatus, so that said document is output from said image forming apparatus in a manner determined in accordance with the input received at said receiving step, and output manner specifying information specifying the manner of output of the document from said image forming apparatus; and
transferring the process request generated at said process request generating step to said image forming apparatus.

18. In an image forming apparatus communicable with an information processing apparatus, a method of image formation in the image forming apparatus operating based on a process request on a document received from said information processing apparatus, wherein
said image forming apparatus includes a display device;
said process request includes guidance information necessary for generating guidance of an operation to be performed by a user in said image forming apparatus, and output manner specifying information specifying the manner of output of a document;
said method comprising the steps of;
generating and displaying on said display device guidance related to a user operation on the document in accordance with the guidance information included in the process request received from said information processing apparatus; and
executing an image forming process on the document to be output in the manner of output specified by the output manner specifying information, based on the output manner specifying information included in the process request received from said information processing apparatus.

19. A computer program product including a computer readable storage medium,
said storage medium storing a computer program causing, when executed by a computer, said computer to execute a method including the steps of:
receiving an input of information related to a document to be processed in said image forming apparatus, and an input determining manner of output from said image forming apparatus as a result of processing of said document;
generating a process request including guidance information necessary to generate guidance of an operation to be performed by a user in said image forming apparatus, so that said document is output from said image forming apparatus in a manner determined in accordance with the input received at said receiving step, and output manner specifying information specifying the manner of output of the document from said image forming apparatus; and
transferring the process request generated at said process request generating step to said image forming apparatus.

20. A computer program product including a computer readable storage medium,
said storage medium storing a computer program causing, when executed by a computer controlling an image forming apparatus, said computer to execute the method including the step of
receiving a process request to said image forming apparatus; wherein
said process request includes guidance information necessary for generating guidance of an operation to be performed by a user in said image forming apparatus, and output manner specifying information specifying the manner of output of a document;
said method further including the steps of
generating and displaying on said display device guidance related to a user operation on the document in accordance with the guidance information included in the process request received at said receiving step; and
executing an image forming process on the document to be output in the manner of output specified by the output manner specifying information, based on the output manner specifying information included in the process request received at said receiving step.
